(19) United States
(12) Patent Application Publication
(10) Pub. No.: US 2021/0191241 A1
(43) Pub. Date: Jun. 24, 2021

(54) PROJECTOR

(71) Applicant: APPOTRONICS CORPORATION LIMITED, Shenzhen (CN)

(72) Inventors: Fenglian Tian, Shenzhen, Guangdong (CN); Chao Liang, Shenzhen, Guangdong (CN); Yi Li, Shenzhen, Guangdong (CN)

(21) Appl. No.: 16/611,899

(22) PCT Filed: Jul. 28, 2017
(86) PCT No.: PCT/CN2017/094803

§ 371 Date: Mar. 3, 2020

(30) Foreign Application Priority Data
May 11, 2017 (CN) 201720519677.5

(51) Int. Cl. G03B 21/16; G03B 21/14

(52) U.S. Cl. CPC G03B 21/16; G03B 21/145

(57) ABSTRACT

A projector, comprising: a housing (1) having an air inlet surface (11) and an air outlet surface (12); and a mainboard (2), a hear radiator (7), a color wheel assembly and a lens module located between the air inlet surface (11) and the air outlet surface (12); the air inlet surface (11) is provided with an air inlet, the air outlet surface (12) is provided with an air outlet (121), and an air passage for gas flow is formed between the air inlet and the air outlet (121); the lens module includes a lens (3) and a protective cover (5) arranged at a periphery of the lens, and the protective cover (5) isolates the lens (3) from the air passage. Said projector can prevent dust from entering the lens and can isolate the lens from the internal space of the projector, facilitating disassembly and maintenance of the lens (3), providing a good user experience.

### TECHNICAL FIELD

The present disclosure relates to the field of optics, and in particular, to an engineering projector.

### BACKGROUND

For example, for an engineering projector with a direct-projective and interchangeable lens, the lens thereof is located at a substantially middle position of a front portion of the machine, and is also just located at a middle position between an air inlet and an air outlet of the entire machine. In this housing, a light-entering surface of the lens is easily contaminated by dust brought into the air duct, and as a result, maintenance of the lens is frequently required.

### SUMMARY

### Technical Problems

In addition, a connection line is provided on a lens holder and is very close to the lens. As a result, the connecting line on the lens holder sometimes will be blocked or clamped when the lens is being disassembled and replaced, which prevents smooth replacement of the lens.

Therefore, it is necessary to provide a new projector to solve the problems described above.

### Solutions to the Problems

A main technical problem to be solved by the present disclosure is to provide a projector with a lens protective cover, so as to solve the problems in the prior art that dust easily enters the lens, it is difficult to maintain the lens and inconvenient to disassemble the lens.

In order to solve the technical problems described above, a technical solution provided by the present disclosure is to provide a projector. The projector includes a housing having an air inlet surface and an air outlet surface; and a lens module located in the housing. The air inlet surface is provided with an air inlet thereon, the air outlet surface is provided with an air outlet thereon, and an air passage for gas flow is formed between the air inlet and the air outlet. The lens module includes a lens and a protective cover arranged at a periphery of the lens for isolating the lens from the air passage.

Preferably, the air inlet surface is opposite to the air outlet surface, and the lens module is located between the air inlet surface and the air outlet surface.

Preferably, the projector further includes a mainboard, a heat radiator, a laser device, and a color wheel assembly that are arranged between the air inlet surface and the air outlet surface.

Preferably, the heat radiator is located between the air inlet and the lens module, and the protective cover includes a first surface close to the heat radiator, a second surface opposite to the first surface, and a third surface connecting the first surface with the second surface.

Preferably, a first fixing portion connected to the housing is provided on the first surface, and a second fixing portion connected to the housing is provided on the second surface.

Preferably, a fan corresponding to the air outlet is provided at the air outlet.

Preferably, the housing includes a lens mounting surface connecting the air inlet surface with the air outlet surface, and the lens mounting surface is provided with a lens mounting hole.

Preferably, the lens module further includes a lens holder connected to the housing and configured to fix the lens and the protective cover, and the lens holder is disposed corresponding to the lens mounting hole.

Preferably, a slot is provided at a side of the third surface close to the lens holder, and the slot is fixed to the lens holder by clamping.

Preferably, the third surface is provided with fixing holes arranged at two sides of the slot; and the protective cover is fixed to the lens holder through the fixing holes.

Preferably, an avoiding portion for the lens is provided at a side of the third surface close to the housing, and the protective cover abuts against an edge of the lens through the avoiding portion.

Preferably, the projector includes a lens connection line which is electrically connected to the lens through the lens holder, a receiving space for the lens is formed between the protective cover and the housing, and the lens connection line is located outside the receiving space.

### Beneficial Effects

The beneficial effects of the present disclosure are that, different from the prior art, the present disclosure provides a projector, in which a protective cover is provided on the lens to prevent dust from entering the lens and isolates the lens from an internal space of the projector, facilitating disassembly and maintenance of the lens, providing a good user experience.

### BRIEF DESCRIPTION OF DRAWINGS

FIG. 1 is a schematic diagram of a partially assembled structure of a projector without a lens according to the present disclosure;

FIG. 2 is a schematic diagram of a partially assembled structure of a projector omitting a partial housing according to the present disclosure;

FIG. 3 is a schematic diagram of a structure of a protective cover of a projector according to the present disclosure; and

FIG. 4 is a schematic diagram of an internal assembly of a projector according to the present disclosure.

### DESCRIPTION OF EMBODIMENTS

It should be understood that specific embodiments described herein are merely illustrative of the present disclosure and are not intended to limit the present disclosure.

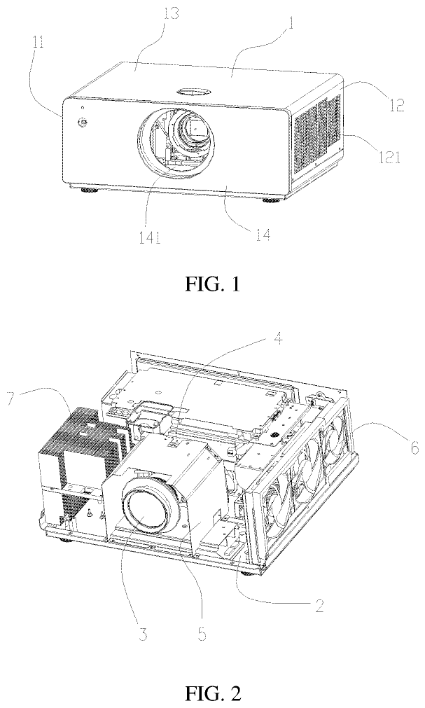

As shown in FIG. 1 and FIG. 2, an embodiment of the present disclosure provides a projector, including a housing 1 having a receiving space, and a mainboard 2, a lens module, a heat radiator 7, a laser device, and a color wheel assembly received in the housing 1.

The housing 1 includes an air inlet surface 11 and an air outlet surface 12 that are perpendicular to the mainboard 2, and a top surface 13 and a bottom surface that connect the air inlet surface 11 with the air outlet surface 12. The lens module, the heat radiator 7, and the color wheel assembly are all located between the air inlet surface 11 and the air outlet surface 12. The mainboard 2 is fixed on the bottom surface of the housing 1. In this embodiment, the mainboard 2 is an independent integrated circuit board fixed on the bottom surface of the housing 1, and a plurality of sockets with different functions can be arranged thereon. Specifically, in the embodiment, the mainboard 2 is provided with a plurality of module sockets, a power supply control socket, and a DMD socket. In other alternative embodiments, the mainboard 2 may also be integrated with the housing 1 at the bottom of the housing 1. Moreover, the mainboard 2 may cover an entire bottom space of the projector or may occupy only a partial space inside the housing, and it is implementable as long as integration is affected.

The air inlet surface 11 is provided with an air inlet, and the air outlet surface 12 is provided with an air outlet 121. The air inlet of the air inlet surface 11 is disposed corresponding to the air outlet 121 of the air outlet surface 12 to form an air passage for gas flow. Further, a fan 6 is provided corresponding to the air outlet 121 for promoting gas flow and enhancing heat dissipation inside the projector.

The lens module includes a lens 3, a lens holder 4 for fixing the lens 3, and a protective cover 5. Further, the housing 1 further includes a lens mounting surface 14 connecting the air inlet surface 11 with the air outlet surface 12 and located between the top surface 12 and the bottom surface. The lens mounting surface 14 is provided with a lens mounting hole 141. The lens 3 is inserted into the housing 1 through the lens mounting hole 141. A light incident direction of the lens 3 is perpendicular to a flow direction of the gas in the air passage. That is, the lens 3 is located on an air receiving surface of the projector.

The lens holder 4 is disposed corresponding to the lens mounting hole 141 to form a mounting position for the lens 3. A lens connection line (or lens connection lines) arranged on the lens holder 4 electrically connects the lens 3 with the mainboard 2, and the lens connection line (or lens connection lines) of the projector is fixed and connected to the lens holder 4.

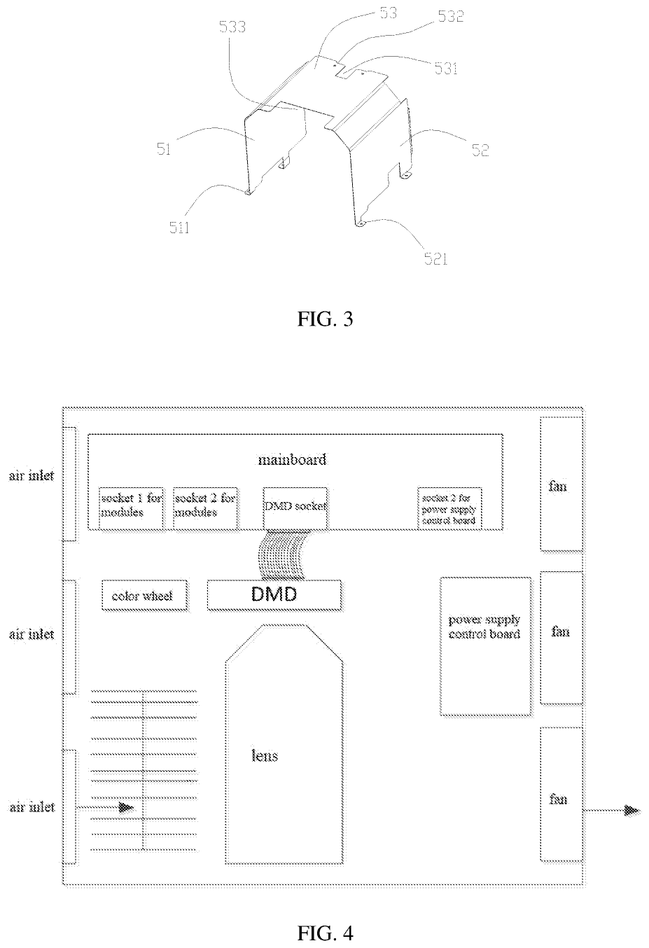

The protective cover 5 is arranged at a periphery of the lens 3, for isolating the lens from the air passage. As shown in FIG. 3, the protective cover 5 includes a first surface 51 disposed opposite to the air inlet surface 11, a second surface 52 disposed opposite to the air outlet surface 12, and a third surface 53 connecting the first surface 51 with the second surface 52. A first fixing portion 511 connected to the mainboard 2 is provided at a side of the first surface 51 close to the mainboard 2, and a second fixing portion 521 connected to the mainboard 2 is provided at a side of the second surface 52 close to the mainboard 2. The protective cover 5 and the housing 1 form a gap around the lens mounting position, in which the receiving space for the lens 3 is formed, and the lens connection line is isolated to be outside the receiving space. In this way, when the lens is disassembled, it is convenient to replace the lens and avoids blocking or clamping the lens connection line to influence reliability of the product. Moreover, an internal space of the projector will not be observed when the lens is disassembled and replaced, thereby ensuring an aesthetic appearance of the product.

A slot 531 is provided at a side of the third surface 53 that is close to the lens holder 4 and away from the lens mounting surface, and the slot 531 is fixed to the lens holder 4 by clamping. Correspondingly, a buckle or a step corresponding thereto is provided on the lens holder, so as to improve fixing reliability of the protective cover 5 and the lens holder 4.

Further, the third surface 53 is further provided with fixing holes 532. Specifically, in this embodiment, two fixing holes 532 are provided and respectively disposed at two sides of the slot 531, for further fixing of the holder 4 and the protective cover. With the fixing holes 532, the fixing holder 4 can be provided with protrusion points or protrusion pillars matched thereto; or with the fixing holes 532, screw fixing can be performed, all of which can be implemented.

Further, an avoiding portion 533 for the lens is provided at a side of the third surface 53 close to the lens mounting surface, and the protective cover 5 abuts against an edge of the lens 3 through the avoiding portion 533. In this way, the lens 3, the protective cover 5 and the lens holder 4 form an integral structure, which plays a dustproof role on the whole.

With reference to FIG. 4, the color wheel assembly includes a color wheel and a color wheel driving device. The laser device is used to emit laser light and generates a lot of heat during operation as a main heat source of the projector. Moreover, a DMD driving device for adjusting imaging and a power supply control board electrically connected to the power supply control board socket on the mainboard may be further provided in the projector and likewise generate heat. Correspondingly, the heat radiator 7 is arranged at an upper layer of the laser device in a heat conductive manner. Specifically, in this embodiment, the laser device and the heat radiator are located between the air inlet and the lens module. An air flow from the air let passes through the heat radiator to cool the projector, and then passes the lens module to flow out from the air outlet under driving of the fan 6, thereby achieving heat dissipation inside the projector.

Different from the prior art, the present disclosure provides a projector, in which a protective cover is provided on the lens to prevent dust from entering the lens and isolates the lens from an internal space of the projector, facilitating disassembly and maintenance of the lens, providing a good user experience.

The above description is merely embodiments of the present disclosure, and not intended to limit the scope of the present disclosure. Any equivalent structures or equivalent process transformations using the specification and companying drawings of the present disclosure, or directly or indirectly applications in other related technical fields are all within the protection scope of the present disclosure.

What is claimed is:

1. A projector, comprising:
a housing having an air inlet surface and an air outlet surface; and
a lens module located in the housing,
wherein the air inlet surface is provided with an air inlet thereon, the air outlet surface is provided with an air outlet thereon, and an air passage for gas flow is formed between the air inlet and the air outlet; and
wherein the lens module comprises a lens and a protective cover arranged at a periphery of the lens for isolating the lens from the air passage.

2. The projector according to claim 1, wherein the air inlet surface is opposite to the air outlet surface, and the lens module is located between the air inlet surface and the air outlet surface.

3. The projector according to claim 2, wherein the projector further comprises a mainboard, a heat radiator, a laser device, and a color wheel assembly that are arranged between the air inlet surface and the air outlet surface.

4. The projector according to claim 3, wherein the heat radiator is located between the air inlet and the lens module, and the protective cover comprises a first surface close to the heat radiator, a second surface opposite to the first surface, and a third surface connecting the first surface with the second surface; and wherein a first fixing portion connected to the housing is provided on the first surface, and a second fixing portion connected to the housing is provided on the second surface.

5. The projector according to claim 1, wherein a fan corresponding to the air outlet is provided at the air outlet.

6. The projector according to claim 1, wherein the housing comprises a lens mounting surface connecting the air inlet surface with the air outlet surface, wherein the lens mounting surface is provided with a lens mounting hole; and
wherein the lens module further comprises a lens holder connected to the housing and configured to fix the lens and the protective cover, wherein the lens holder is disposed corresponding to the lens mounting hole.

7. The projector according to claim 4, wherein a slot is provided at a side of the third surface close to the lens holder, the slot is fixed to the lens holder by clamping, and the lens module further comprises a lens holder connected to the housing and configured to fix the lens and the protective cover.

8. The projector according to claim 7, wherein the third surface is provided with fixing holes arranged at two sides of the slot, and the protective cover is fixed to the lens holder through the fixing holes.

9. The projector according to claim 6, wherein an avoiding portion for the lens is provided at a side of the third surface close to the lens mounting surface, and the protective cover abuts against an edge of the lens through the avoiding portion.

10. The projector according to claim 6, wherein the projector comprises a lens connection line which is electrically connected to the lens through the lens holder, a receiving space for the lens is formed between the protective cover and the housing, and the lens connection line is located outside the receiving space.
